(19) United States
(12) Patent Application Publication
(10) Pub. No.: US 2004/0251168 A1
(43) Pub. Date: Dec. 16, 2004

(54) Process improvement for desulfurization unit

(76) Inventors: Paul F. Meier, Bartlesville, OK (US); Steven L. Lacy, Borger, TX (US); Jason J. Gislason, Bartlesville, OK (US)

Correspondence Address: RICHMOND, HITCHCOCK, FISH & DOLLAR, P.O. Box 2443, Bartlesville, OK, 74005, US

(21) Appl. No.: 10/461,077

(22) Filed: Jun. 13, 2003

(51) Int. Cl. C10G 25/12; C10G 25/00; C10G 29/04; B01J 8/18

(52) U.S. Cl. 208/208 R; 208/305; 208/243; 208/244; 208/246; 208/247; 208/299; 422/139; 422/141; 422/142

(57) ABSTRACT

A desulfurization system employing fluidizable and circulatable finely divided solid sorbent particulates that are transported between reactor, regenerator, and reducer vessels. Agglomeration of the sorbent particulates is minimized and circulation of the sorbent particulates is enhanced by controlling the location at which the sorbent particulates are withdrawn from the reducer.

### BACKGROUND OF THE INVENTION

This invention relates to a system for desulfurizing a hydrocarbon-containing fluid via contacting of the hydrocarbon-containing fluid with finely divided solid sorbent particulates. In another aspect, the invention concerns a desulfurization unit that circulates solid sorbent particulates between a reactor, a regenerator, and a reducer to allow for continuous desulfurization in the reactor.

Hydrocarbon-containing fluids such as gasoline and diesel fuels typically contain a quantity of sulfur. High levels of sulfurs in such automotive fuels are undesirable because oxides of sulfur present in automotive exhaust may irreversibly poison noble metal catalysts employed in automobile catalytic converters. Emissions from such poisoned catalytic converters may contain high levels of non-combusted hydrocarbons, oxides of nitrogen, and/or carbon monoxide, which, when catalyzed by sunlight, form ground level ozone, more commonly referred to as smog.

Much of the sulfur present in the final blend of most gasolines originates from a gasoline blending component commonly known as “cracked-gasoline.” Thus, reduction of sulfur levels in cracked-gasoline will inherently serve to reduce sulfur levels in most gasolines, such as, automobile gasolines, racing gasolines, aviation gasolines, boat gasolines, and the like. Many conventional processes exist for removing sulfur from cracked-gasoline. However, most conventional sulfur removal processes, such as hydrodesulfurization, tend to saturate olefins and aromatics in the cracked-gasoline and thereby reduce its octane number (both research and motor octane number). Thus, there is a need for a process wherein desulfurization of cracked-gasoline is achieved while the octane number is maintained.

In addition to the need for removing sulfur from cracked-gasoline, there is also a need to reduce the sulfur content in diesel fuel. In removing sulfur from diesel fuel by hydrodesulfurization, the cetane is improved but there is a large cost in hydrogen consumption. Such hydrogen is consumed by both hydrodesulfurization and aromatic hydrogenation reactions. Thus, there is a need for a process wherein desulfurization of diesel fuel is achieved without significant consumption of hydrogen so as to provide a more economical desulfurization process.

Traditionally, sorbent compositions used in processes for removing sulfur from hydrocarbon-containing fluids, such as cracked-gasoline and diesel fuel, have been agglomerates utilized in fixed bed applications. Because fluidized bed reactors present a number of advantages over fixed bed reactors, hydrocarbon-containing fluids are sometimes processed in fluidized bed reactors. One advantage of using fluidized bed reactors is that rapid mixing of solids in fluidized bed reactors gives nearly isothermal conditions throughout the reactor leading to reliable control of the reactor and, if necessary, easy removal of heat. Also, the flowability of the solid sorbent particulates employed in fluidized bed reactors allows the sorbent particulates to be circulated between two or more vessels, an ideal condition when the sorbent needs frequent regeneration. However, problems can be encountered when transporting solid sorbent particulates between different vessels operating at different conditions. For example, in desulfurization units that circulate finely divided solid sorbent particulates between a fluidized bed reactor, a fluidized bed regenerator, and a fluidized bed reducer, agglomeration of the sorbent particulates withdrawn from the reducer can cause plugging of the transport assembly between the reducer and the reactor. Such plugging of the transport assembly due to sorbent agglomeration can necessitate frequent shut-downs of the desulfurization unit in order to remove sorbent plugging the transport assembly.

### SUMMARY OF THE INVENTION

Accordingly, it is an object of the present invention to provide a novel desulfurization system that minimizes agglomeration of solid sorbent particulates.

Another object of the present invention is to provide a novel reducer vessel operable to minimize agglomeration of solid sorbent particulates withdrawn from such reducer.

It should be noted that the above-listed objects need not all be accomplished by the invention claimed herein and other objects and advantages of this invention will be apparent from the following description of the preferred embodiments and appended claims.

Accordingly, in one embodiment of the present invention, there is provided a desulfurization unit comprising a reducer vessel and a fluidized bed of sorbent particulates. The reducer vessel defines a reducing zone within which the fluidized bed is disposed. The reducer vessel includes a distribution grid configured to allow a fluid to flow upwardly therethrough and into the reducing zone. The reducing zone is located generally above the distribution grid. The reducer vessel includes a sorbent draw for removing a portion of the sorbent particulates from the reducing zone. The sorbent draw includes a draw opening through which the sorbent enters the sorbent draw from the reducing zone. The draw opening is vertically spaced from the distribution grid at a draw height that is less than about one third the height of the fluidized bed.

In another embodiment of the present invention, there is provided a desulfurization unit employing fluidizable and circulatable sorbent particulates. The desulfurization unit comprises a reactor, a regenerator, a reducer, a first transport assembly, a second transport assembly, and a third transport assembly. The reactor, regenerator, and reducer contain first, second, and third fluidized beds of sorbent particulates. The first transport assembly is operable to transport the sorbent particulates from the reactor to the regenerator. The second transport assembly is operable to transport the sorbent particulates from the regenerator to the reducer. The third transport assembly is operable to transport the sorbent particulates from the reducer to the reactor. The reducer includes a sorbent draw fluidly coupled to the third transport assembly and operable to withdraw sorbent particulates from the third fluidized bed. The sorbent draw is configured to withdraw the sorbent particulates from a bottom one third of the third fluidized bed.

In a further embodiment of the present invention, a method of desulfurizing a hydrocarbon-containing fluid stream is provided. The method comprises the steps of: (a) contacting sorbent particulates with the hydrocarbon-containing fluid stream in a reactor to thereby remove sulfur from the hydrocarbon-containing fluid stream and provide sulfur-loaded sorbent particulates; (b) transporting at least a portion of the sulfur-loaded sorbent particulates from the reactor to a regenerator; (c) contacting the sulfur-loaded sorbent particulates with an oxygen-containing stream in the regenerator to thereby provide regenerated sorbent particulates; (d) transporting at least a portion of the regenerated sorbent particulates from the regenerator to a reducer; (e) contacting the regenerated sorbent particulates with a hydrogen-containing stream in the reducer to thereby provide reduced sorbent particulates; and (f) transporting at least a portion of the reduced sorbent particulates from the reducer to the reactor. Step (e) includes fluidizing the regenerated and reduced sorbent particulates with the hydrogen-containing stream in the reducer to thereby form a fluidized bed of the regenerated sorbent particulates and the reduced sorbent particulates in the reducer. Step (f) includes removing at least a portion of the reduced sorbent particulates from the reducer at a draw location positioned proximate a bottom one third of the fluidized bed.

### BRIEF DESCRIPTION OF THE DRAWINGS

FIG. 1 is a schematic diagram of a desulfurization unit constructed in accordance with the principals of the present invention, particularly illustrating the circulation of regenerable solid sorbent particulates through the reactor, regenerator, and reducer.

FIG. 2 is an upwardly skewed sectional side view of a reducer constructed in accordance with the principals of the present invention, particularly illustrating the location of a sorbent draw operable to remove sorbent particulates from a lower portion of the fluidized bed of sorbent particulates in the reducer.

### DETAILED DESCRIPTION OF THE PREFERRED EMBODIMENTS

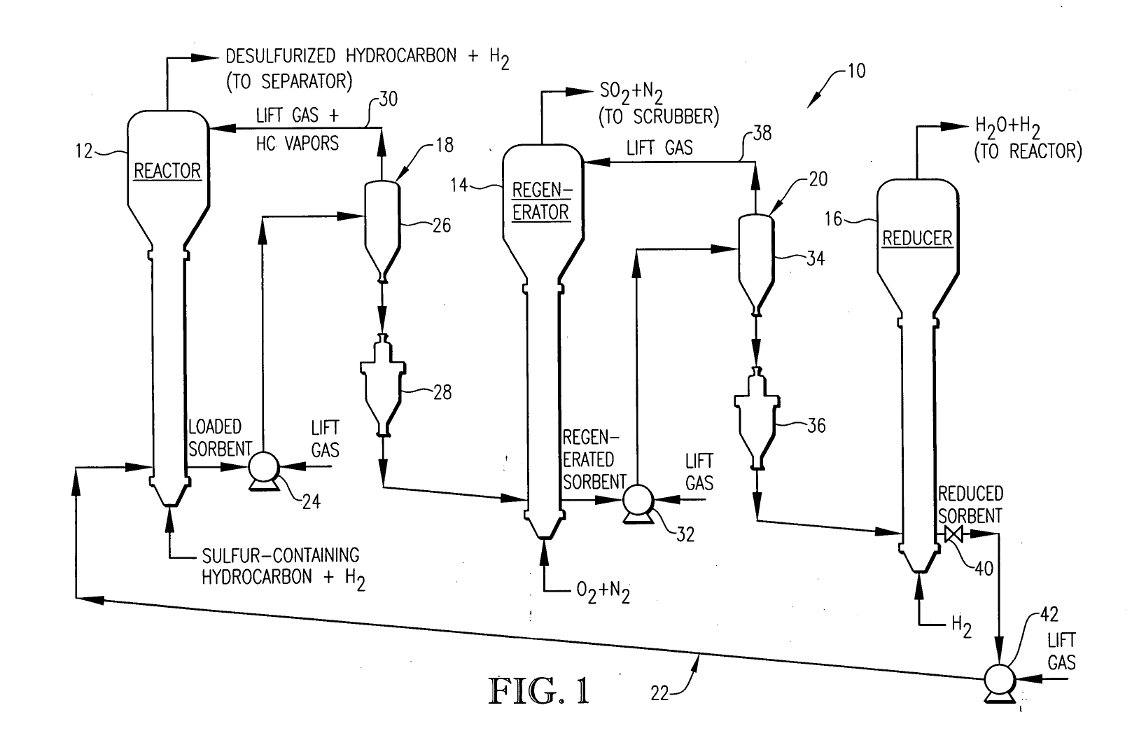

Referring initially to FIG. 1, a desulfurization unit 10 is illustrated as generally comprising a fluidized bed reactor 12, a fluidized bed regenerator 14, and a fluidized bed reducer 16. Solid sorbent particulates are circulated in desulfurization unit 10 to provide for substantially continuous sulfur removal from a sulfur-containing hydrocarbon, such as cracked-gasoline or diesel fuel. The solid sorbent particulates employed in desulfurization unit 10 can be any sufficiently fluidizable, circulatable, and regenerable zinc oxide-based composition having sufficient desulfurization activity and sufficient attrition resistance. A description of such a sorbent composition is provided in U.S. patent application Ser. No. 09/580,611 and U.S. patent application Ser. No. 10/072,209, the entire disclosures of which are incorporated herein by reference.

In fluidized bed reactor 12, a hydrocarbon-containing fluid stream is passed upwardly through a bed of reduced solid sorbent particulates, thereby forming a fluidized bed of reduced solid sorbent particulates in reactor 12. The reduced solid sorbent particulates contacted with the hydrocarbon-containing stream in reactor 12 preferably initially (i.e., immediately prior to contacting with the hydrocarbon-containing fluid stream) comprise zinc oxide and a reduced-valence promoter metal component. Though not wishing to be bound by theory, it is believed that the reduced-valence promoter metal component of the reduced solid sorbent particulates facilitates the removal of sulfur from the hydrocarbon-containing stream, while the zinc oxide operates as a sulfur storage mechanism via its conversion to zinc sulfide.

The reduced-valence promoter metal component of the reduced solid sorbent particulates preferably comprises a promoter metal selected from a group consisting of nickel, cobalt, iron, manganese, tungsten, silver, gold, copper, platinum, zinc, tin, ruthenium, molybdenum, antimony, vanadium, iridium, chromium, palladium. More preferably, the reduced-valence promoter metal component comprises nickel as the promoter metal. As used herein, the term “reduced-valence” when describing the promoter metal component, shall denote a promoter metal component having a valence which is less than the valence of the promoter metal component in its common oxidized state. More specifically, the reduced solid sorbent particulates employed in reactor 12 should include a promoter metal component having a valence which is less than the valence of the promoter metal component of the regenerated (i.e., oxidized) solid sorbent particulates exiting regenerator 14. Most preferably, substantially all of the promoter metal component of the reduced solid sorbent particulates has a valence of zero.

In a preferred embodiment of the present invention, the reduced-valence promoter metal component comprises, consists of, or consists essentially of, a substitutional solid metal solution characterized by the formula: M_{A}Zn_{B}, wherein M is the promoter metal and A and B are each numerical values in the range of from 0.01 to 0.99. In the above formula for the substitutional solid metal solution, it is preferred for A to be in the range of from about 0.70 to about 0.97, and most preferably in the range of from about 0.85 to about 0.95. It is further preferred for B to be in the range of from about 0.03 to about 0.30, and most preferably in the range of from about 0.05 to 0.15. Preferably, B is equal to (1−A).

Substitutional solid solutions have unique physical and chemical properties that are important to the chemistry of the sorbent composition described herein. Substitutional solid solutions are a subset of alloys that are formed by the direct substitution of the solute metal for the solvent metal atoms in the crystal structure. For example, it is believed that the substitutional solid metal solution (M_{A}Zn_{B}) found in the reduced solid sorbent particulates is formed by the solute zinc metal atoms substituting for the solvent promoter metal atoms. There are three basic criteria that favor the formation of substitutional solid solutions: (1) the atomic radii of the two elements are within 15 percent of each other; (2) the crystal structures of the two pure phases are the same; and (3) the electronegativities of the two components are similar. The promoter metal (as the elemental metal or metal oxide) and zinc oxide employed in the solid sorbent particulates described herein preferably meet at least two of the three criteria set forth above. For example, when the promoter metal is nickel, the first and third criteria, are met, but the second is not. The nickel and zinc metal atomic radii are within 10 percent of each other and the electronegativities are similar. However, nickel oxide (NiO) preferentially forms a cubic crystal structure, while zinc oxide (ZnO) prefers a hexagonal crystal structure. A nickel zinc solid solution retains the cubic structure of the nickel oxide. Forcing the zinc oxide to reside in the cubic structure increases the energy of the phase, which limits the amount of zinc that can be dissolved in the nickel oxide structure. This stoichiometry control manifests itself microscopically in about a 92:8 nickel zinc solid solution (Ni_{0.92}Zn_{0.08}) that is formed during reduction and microscopically in the repeated regenerability of the solid sorbent particulates.

In addition to zinc oxide and the reduced-valence promoter metal component, the reduced solid sorbent particulates employed in reactor 12 may further comprise a porosity enhancer and an aluminate. The aluminate is preferably a promoter metal-zinc aluminate substitutional solid solution. The promoter metal-zinc aluminate substitutional solid solution can be characterized by the formula: M_{Z}Zn_{(1-Z)}Al₂O₄, wherein Z is a numerical value in the range of from 0.01 to 0.99. The porosity enhancer, when employed, can be any compound which ultimately increases the macroporosity of the solid sorbent particulates. Preferably, the porosity enhancer is perlite. The term “perlite” as used herein is a petrographic term for a siliceous volcanic rock which naturally occurs in certain regions throughout the world. The distinguishing feature, which sets perlite apart from other volcanic minerals, is its ability to expand four to twenty times its original volume when heated to certain temperatures. When heated above 1600° F., crushed perlite expands due to the presence of combined water with the crude perlite rock. The combined water vaporizes during the heating process and creates countless tiny bubbles in the heat softened glassy particles. It is these diminutive glass sealed bubbles which account for its light weight. Expanded perlite can be manufactured to weigh as little as 2.5 lbs per cubic foot. Typical chemical analysis properties (by weight) of expanded perlite are: silicon dioxide 73%, aluminum oxide 17%, potassium oxide 5%, sodium oxide 3%, calcium oxide 1%, plus trace elements. Typical physical properties of expanded perlite are: softening point 1,600-2,000° F., fusion point 2,300° F.-2,450° F., pH 6.6-6.8, and specific gravity 2.2-2.4. The term “expanded perlite” as used herein refers to the spherical form of perlite which has been expanded by heating the perlite siliceous volcanic rock to a temperature above 1,600° F. The term “particulate expanded perlite” or “milled perlite” as used herein denotes that form of expanded perlite which has been subjected to crushing so as to form a particulate mass wherein the particle size of such mass is comprised of at least 97% of particles having a size of less than two microns. The term “milled expanded perlite” is intended to mean the product resulting from subjecting expanded perlite particles to milling or crushing.

The reduced solid sorbent particulates initially contacted with the hydrocarbon-containing fluid stream in reactor 12 can comprise zinc oxide, the reduced-valence promoter metal component (M_{A}Zn_{B}), the porosity enhancer (PE), and the promoter metal-zinc aluminate (M_{Z}Zn_{(1-Z)}Al₂O₄) in the ranges provided below in Table 1.

TABLE 1
Components of the Reduced Solid Sorbent Particulates

| | ZnO | M_{A}Zn_{B} | PE | M_{Z}Zn_{(1-Z)}Al₂O₄ |
|---|---|---|---|---|
| Range | (wt %) | (wt %) | (wt %) | (wt %) |
| Preferred | 5-80 | 5-80 | 2-50 | 1-50 |
| More Preferred | 20-60 | 7-60 | 5-30 | 5-30 |
| Most Preferred | 30-50 | 10-40 | 10-20 | 10-20 |

The physical properties of the solid sorbent particulates which significantly affect the particulates' suitability for use in desulfurization unit 10 include, for example, particle shape, particle size, particle density, and resistance to attrition. The solid sorbent particulates employed in desulfurization unit 10 preferably comprise finely divided, substantially microspherical, preferably spray-dried, particles having a mean particle size that is less than about 500 microns, more preferably less than about 300 microns, and most preferably less than about 100 microns. The mean particle size of the solid sorbent particulates is preferably in the range of from about 20 to about 300 microns, more preferably in the range of about 40 to about 100 microns, for best fluidization in the desulfurization unit and transportability throughout the system.

The average density of the solid sorbent particulates is preferably in the range of from about 0.5 to about 1.5 grams per cubic centimeter (g/cc), more preferably in the range of from about 0.8 to about 1.3 g/cc, and most preferably in the range of from 0.9 to 1.2 g/cc, for the reasons given above. The particle size and density of the solid sorbent particulates preferably qualify the solid sorbent particulates as a Group A solid under the Geldart group classification system described in Powder Technol., 7, 285-292 (1973).

The solid sorbent particulates preferably have high resistance to attrition. As used herein, the term “attrition resistance” denotes a measure of a particle's resistance to size reduction under controlled conditions of turbulent motion. The attrition resistance of a particle can be quantified using the jet cup attrition test, similar to the Davison Index. The Jet Cup Attrition Index represents the weight percent of the over 44 micrometer (μ) particle size fraction which is reduced to particle sizes of less than 37 micrometers under test conditions and involves screening a 5 gram sample of sorbent to remove particles in the 0 to 44 micrometer size range. The particles above 44 micrometers are then subjected to a tangential jet of air at a rate of 21 liters per minute introduced through a 0.0625 inch orifice fixed at the bottom of a specially designed jet cup (1″ I.D.×2″ height) for a period of 1 hour. The jet cup attrition test is calculated as follows:

$$DI = \frac{Wt . of 0 \text{-} 37 Micrometer Formed During Test}{Wt . of Original + 44 Micrometer Fraction Being Tested} \times 100 \times Correction Factor$$

The Correction Factor (presently 0.3) is determined by using a known calibration standard to adjust for differences in jet cup dimensions and wear. The solid sorbent particulates employed in the present invention preferably have a jet cup attrition index value of less than of less than about 20, more preferably less than about 15, still more preferably less than about 12, and most preferably less than 10.

The solid sorbent particulates employed in the present invention preferably have a Jet Cup Attrition Index value of less than about 30, more preferably less than about 20, and most preferably less than 15, for longer use in the desulfurization system.

The hydrocarbon-containing fluid stream contacted with the reduced solid sorbent particulates in reactor 12 preferably comprises a sulfur-containing hydrocarbon and hydrogen. The molar ratio of the hydrogen to the sulfur-containing hydrocarbon charged to reactor 12 is preferably in the range of from about 0.1:1 to about 3:1, more preferably in the range of from about 0.2:1 to about 1:1, and most preferably in the range of from 0.4:1 to 0.8:1. Preferably, the sulfur-containing hydrocarbon is a fluid which is normally in a liquid state at standard temperature and pressure, but which exists in a gaseous state when combined with hydrogen, as described above, and exposed to the desulfurization conditions in reactor 12. The sulfur-containing hydrocarbon preferably can be used as a fuel or a precursor to fuel. Examples of suitable sulfur-containing hydrocarbons include cracked-gasoline, diesel fuels, jet fuels, straight-run naphtha, straight-run distillates, coker gas oil, coker naphtha, alkylates, and straight-run gas oil. Most preferably, the sulfur-containing hydrocarbon comprises a hydrocarbon fluid selected from the group consisting of gasoline, cracked-gasoline, diesel fuel, and mixtures thereof.

As used herein, the term “gasoline” denotes a mixture of hydrocarbons boiling in a range of from about 100° F. to about 400° F., or any fraction thereof. Examples of suitable gasolines include, but are not limited to, hydrocarbon streams in refineries such as naphtha, straight-run naphtha, coker naphtha, catalytic gasoline, visbreaker naphtha, alkylates, isomerate, reformate, and the like, and mixtures thereof.

As used herein, the term “cracked-gasoline” denotes a mixture of hydrocarbons boiling in a range of from about 100° F. to about 400° F., or any fraction thereof, that are products of either thermal or catalytic processes that crack larger hydrocarbon molecules into smaller molecules. Examples of suitable thermal processes include, but are not limited to, coking, thermal cracking, visbreaking, and the like, and combinations thereof. Examples of suitable catalytic cracking processes include, but are not limited to, fluid catalytic cracking, heavy oil cracking, and the like, and combinations thereof Thus, examples of suitable cracked-gasolines include, but are not limited to, coker gasoline, thermally cracked gasoline, visbreaker gasoline, fluid catalytically cracked gasoline, heavy oil cracked-gasoline and the like, and combinations thereof. In some instances, the cracked-gasoline may be fractionated and/or hydrotreated prior to desulfurization when used as the sulfur-containing fluid in the process in the present invention.

As used herein, the term “diesel fuel” denotes a mixture of hydrocarbons boiling in a range of from about 300° F. to about 750° F., or any fraction thereof. Examples of suitable diesel fuels include, but are not limited to, light cycle oil, kerosene, jet fuel, straight-run diesel, hydrotreated diesel, and the like, and combinations thereof.

The sulfur-containing hydrocarbon described herein as suitable feed in the inventive desulfurization process comprises a quantity of olefins, aromatics, and sulfur, as well as paraffins and naphthenes. The amount of olefins in gaseous cracked-gasoline is generally in a range of from about 10 to about 35 weight percent olefins based on the total weight of the gaseous cracked-gasoline. For diesel fuel there is essentially no olefin content. The amount of aromatics in gaseous cracked-gasoline is generally in a range of from about 20 to about 40 weight percent aromatics based on the total weight of the gaseous cracked-gasoline. The amount of aromatics in gaseous diesel fuel is generally in a range of from about 10 to about 90 weight percent aromatics based on the total weight of the gaseous diesel fuel. The amount of atomic sulfur in the sulfur-containing hydrocarbon fluid, preferably cracked-gasoline or diesel fuel, suitable for use in the inventive desulfurization process is generally greater than about 50 parts per million by weight (ppmw) of the sulfur-containing hydrocarbon fluid, more preferably in a range of from about 100 ppmw atomic sulfur to about 10,000 ppmw atomic sulfur, and most preferably from 150 ppmw atomic sulfur to 500 ppmw atomic sulfur. It is preferred for at least about 50 weight percent of the atomic sulfur present in the sulfur-containing hydrocarbon fluid employed in the present invention to be in the form of organosulfur compounds. More preferably, at least about 75 weight percent of the atomic sulfur present in the sulfur-containing hydrocarbon fluid is in the form of organosulfur compounds, and most preferably at least 90 weight percent of the atomic sulfur is in the form of organosulfur compounds. As used herein, “sulfur” used in conjunction with “ppmw sulfur” or the term “atomic sulfur”, denotes the amount of atomic sulfur (about 32 atomic mass units) in the sulfur-containing hydrocarbon, not the atomic mass, or weight, of a sulfur compound, such as an organosulfur compound.

As used herein, the term “sulfur” denotes sulfur in any form normally present in a sulfur-containing hydrocarbon such as cracked-gasoline or diesel fuel. Examples of such sulfur which can be removed from a sulfur-containing hydrocarbon fluid through the practice of the present invention include, but are not limited to, hydrogen sulfide, carbonal sulfide (COS), carbon disulfide (CS₂), mercaptans (RSH), organic sulfides (R—S—R), organic disulfides (R—S—S—R), thiophene, substituted thiophenes, organic trisulfides, organic tetrasulfides, benzothiophene, alkyl thiophenes, alkyl benzothiophenes, alkyl dibenzothiophenes, and the like, and combinations thereof, as well as heavier molecular weights of the same which are normally present in sulfur-containing hydrocarbons of the types contemplated for use in the desulfurization process of the present invention, wherein each R can be any alkyl, cycloalkyl, or aryl group containing one to 10 carbon atoms.

As used herein, the term “fluid” denotes gas, liquid, vapor, and combinations thereof.

As used herein, the term “gaseous” denotes the state in which the sulfur-containing hydrocarbon fluid, such as cracked-gasoline or diesel fuel, is primarily in a gas or vapor phase.

In fluidized bed reactor 12, the finely divided reduced solid sorbent particulates are contacted with the upwardly flowing gaseous hydrocarbon-containing fluid stream under a set of desulfurization conditions sufficient to produce a desulfurized hydrocarbon and sulfur-loaded solid sorbent particulates. The flow of the hydrocarbon-containing fluid stream is sufficient to fluidize the bed of solid sorbent particulates located in reactor 12. The desulfurization conditions in reactor 12 include temperature, pressure, weighted hourly space velocity (WHSV), and superficial velocity. The preferred ranges for such desulfurization conditions, for best desulfurization results, are provided below in Table 2.

TABLE 2
Desulfurization Conditions

| | Temp | | WHSV | Superficial Vel. |
|---|---|---|---|---|
| Range | (° F.) | Press. (psig) | (hr⁻¹) | (ft/s) |
| Preferred | 250-1200 | 25-750 | 1-20 | 0.25-5 |
| More Preferred | 500-1000 | 100-400 | 2-12 | 0.5-2.5 |
| Most Preferred | 700-850 | 150-250 | 3-10 | 1-2 |

When the reduced solid sorbent particulates are contacted with the hydrocarbon-containing stream in reactor 12 under desulfurization conditions, sulfur compounds, particularly organosulfur compounds, present in the hydrocarbon-containing fluid stream are removed from such fluid stream. At least a portion of the sulfur removed from the hydrocarbon-containing fluid stream is employed to convert at least a portion of the zinc oxide of the reduced solid sorbent particulates into zinc sulfide.

In contrast to many conventional sulfur removal processes (e.g., hydrodesulfurization), it is preferred that substantially none of the sulfur in the sulfur-containing hydrocarbon fluid is converted to, and remains as, hydrogen sulfide during desulfurization in reactor 12. Rather, it is preferred that the fluid effluent from reactor 12 (generally comprising the desulfurized hydrocarbon and hydrogen) comprises less than the amount of hydrogen sulfide, if any, in the fluid feed charged to reactor 12 (generally comprising the sulfur-containing hydrocarbon and hydrogen). The fluid effluent from reactor 12 preferably contains less than about 50 weight percent of the amount of sulfur in the fluid feed charged to reactor 12, more preferably less than about 20 weight percent of the amount of sulfur in the fluid feed, and most preferably less than five weight percent of the amount of sulfur in the fluid feed. It is preferred for the total sulfur content of the fluid effluent from reactor 12 to be less than about 50 parts per million by weight (ppmw) of the total fluid effluent, more preferably less than about 30 ppmw, still more preferably less than about 15 ppmw, and most preferably less than 10 ppmw.

After desulfurization in reactor 12, the desulfurized hydrocarbon fluid, preferably desulfurized cracked-gasoline or desulfurized diesel fuel, can thereafter be separated and recovered from the fluid effluent and preferably liquified. The liquification of such desulfurized hydrocarbon fluid can be accomplished by any method or manner known in the art. The resulting liquified, desulfurized hydrocarbon preferably comprises less than about 50 weight percent of the amount of sulfur in the sulfur-containing hydrocarbon (e.g., cracked-gasoline or diesel fuel) charged to the reaction zone, more preferably less than about 20 weight percent of the amount of sulfur in the sulfur-containing hydrocarbon, and most preferably less than five weight percent of the amount of sulfur in the sulfur-containing hydrocarbon. The desulfurized hydrocarbon preferably comprises less than about 50 ppmw sulfur, more preferably less than about 30 ppmw sulfur, still more preferably less than about 15 ppmw sulfur, and most preferably less than 10 ppmw sulfur.

After desulfurization in reactor 12, at least a portion of the sulfur-loaded sorbent particulates are transported to regenerator 14 via a first transport assembly 18. In regenerator 14, the sulfur-loaded solid sorbent particulates are contacted with an oxygen-containing regeneration stream. In regenerator 14, the oxygen-containing regeneration stream flows upwardly through the sorbent particulates, thereby forming a fluidized bed of the sorbent particulates in regenerator 14. The physical properties (e.g., particle shape, particle size, particle density, attrition resistance, and fluidized density) of the sorbent particulates in regenerator 14 are preferably substantially the same as described above with reference to the sorbent particulates in reactor 12, for best sorbent regeneration. The oxygen-containing regeneration stream preferably comprises at least one mole percent oxygen with the remainder being a gaseous diluent. More preferably, the oxygen-containing regeneration stream comprises in the range of from about one to about 50 mole percent oxygen and in the range of from about 50 to about 95 mole percent nitrogen, still more preferable in the range of from about two to about 20 mole percent oxygen and in the range of from about 70 to about 90 mole percent nitrogen, and most preferably in the range of from three to 10 mole percent oxygen and in the range of from 75 to 85 mole percent nitrogen. Other components can be present, provided that these components do not substantially interfere with regeneration of sorbent.

The regeneration conditions in regenerator 14 are sufficient to convert at least a portion of the zinc sulfide of the sulfur-loaded solid sorbent particulates into zinc oxide via contacting with the oxygen-containing regeneration stream. The preferred ranges for such regeneration conditions are provided below in Table 3.

TABLE 3
Regeneration Conditions

| | Temp | Press. | Superficial |
|---|---|---|---|
| Range | (° F.) | (psig) | Vel. (ft/s) |
| Preferred | 500-1500 | 10-250 | 0.5-10 |
| More Preferred | 700-1200 | 20-150 | 1.0-5.0 |
| Most Preferred | 900-1100 | 30-75 | 2.0-2.5 |

When the sulfur-loaded solid sorbent particulates are contacted with the oxygen-containing regeneration stream under the regeneration conditions described above, at least a portion of the promoter metal component is oxidized to form an oxidized promoter metal component. Preferably, in regenerator 14 the substitutional solid metal solution (M_{A}Zn_{B}) and/or sulfided substitutional solid metal solution (M_{A}Zn_{B}S) of the sulfur-loaded sorbent is converted to a substitutional solid metal oxide solution characterized by the formula: M_{X}Zn_{Y}O, wherein M is the promoter metal and X and Y are each numerical values in the range of from 0.01 to about 0.99. In the above formula, it is preferred for X to be in the range of from about 0.5 to about 0.9 and most preferably from 0.6 to 0.8. It is further preferred for Y to be in the range of from about 0.1 to about 0.5, and most preferably from 0.2 to 0.4. Preferably, Y is equal to (1−X).

The regenerated solid sorbent particulates exiting regenerator 14 can comprise zinc oxide, the oxidized promoter metal component (M_{X}Zn_{Y}O), the porosity enhancer (PE), and the promoter metal-zinc aluminate (M_{Z}Zn_{(1-Z)}Al₂O₄) in the ranges provided below in Table 4.

TABLE 4
Components of the Regenerated Solid Sorbent Particulates

| | ZnO | M_{X}Zn_{Y}O | PE | M_{Z}Zn_{(1-Z)}Al₂O₄ |
|---|---|---|---|---|
| Range | (wt %) | (wt %) | (wt %) | (wt %) |
| Preferred | 5-80 | 5-70 | 2-50 | 1-50 |
| More Preferred | 20-60 | 7-60 | 5-30 | 5-30 |
| Most Preferred | 30-50 | 10-40 | 10-20 | 10-20 |

After regeneration in regenerator 14, the regenerated (i.e., oxidized) solid sorbent particulates are transported to reducer 16 via a second transport assembly 20. In reducer 16, the regenerated solid sorbent particulates are contacted with a hydrogen-containing reducing stream. In reducer 16, the hydrogen-containing reducing stream flows upwardly through the sorbent particulates, thereby forming a fluidized bed of the sorbent particulates in reducer 16. The physical properties (e.g., particle shape, particle size, particle density, attrition resistance, and fluidized density) of the sorbent particulates in reducer 16 are preferably substantially the same as the physical properties described above with reference to the sorbent particulates in reactor 12. The hydrogen-containing reducing stream employed in reducer 16 preferably comprises predominately (i.e., at least about 50 mole percent) hydrogen with the remainder being cracked hydrocarbon products such as, for example, methane, ethane, and/or propane. More preferably, the hydrogen-containing reducing stream comprises about 70 mole percent hydrogen, and most preferably at least 80 mole percent hydrogen. The reducing conditions in reducer 16 are sufficient to reduce the valence of the oxidized promoter metal component of the regenerated solid sorbent particulates. The preferred ranges for such reducing conditions are provided below in Table 5.

TABLE 5
Reducing Conditions

| | Temperature | Pressure | Superficial |
|---|---|---|---|
| Range | (° F.) | (psig) | Velocity (ft/s) |
| Preferred | 250-1250 | 25-750 | 0.1-4 |
| More Preferred | 600-1000 | 100-400 | 0.2-3 |
| Most Preferred | 750-850 | 150-250 | 0.3-2.5 |

When the regenerated solid sorbent particulates are contacted with the hydrogen-containing reducing stream in reducer 16 under the reducing conditions described above, at least a portion of the oxidized promoter metal component is reduced to form the reduced-valence promoter metal component. Preferably, at least a substantial portion of the substitutional solid metal oxide solution (M_{X}Zn_{Y}O) is converted to the reduced-valence promoter metal component (M_{A}Zn_{B}). Also, water is typically produced in reducer 16 due to the reaction of the oxidized promoter metal component and the hydrogen-containing reducing stream.

After the solid sorbent particulates have been reduced in reducer 16, they can be transported back to reactor 12 via a third transport assembly 22 for recontacting with the hydrocarbon-containing fluid stream in reactor 12. If reducer 16 and third transport assembly 22 are not properly configured, the water produced in reducer 16 via the reaction of the hydrogen-containing reducing stream and the oxidized promoter metal component can cause agglomeration of sorbent particulates in third transport assembly 22. Such agglomerated sorbent particulates can result in plugging of certain components in third transport assembly 22.

Referring again to FIG. 1, first transport assembly 18 generally comprises a reactor lifting device, such as, for example, a pneumatic lift, 24, a reactor receiver 26, and a reactor lockhopper 28 fluidly disposed between reactor 12 and regenerator 14. During operation of desulfurization unit 10 the sulfur-loaded sorbent particulates are continuously withdrawn from reactor 12 and lifted by reactor pneumatic lift 24 from reactor 12 to reactor receiver 18. Reactor receiver 18 is fluidly coupled to reactor 12 via a reactor return line 30. The lift agent, such as for example, a gas, used to transport the sulfur-loaded sorbent particulates from reactor 12 to reactor receiver 26 is separated from the sulfur-loaded sorbent particulates in reactor receiver 26 and returned to reactor 12 via reactor return line 30. Reactor lockhopper 26 is operable to transition the sulfur-loaded sorbent particulates from the high pressure hydrocarbon environment of reactor 12 and reactor receiver 26 to the low pressure oxygen environment of regenerator 14. To accomplish this transition, reactor lockhopper 28 periodically receives batches of the sulfur-loaded sorbent particulates from reactor receiver 26, isolates the sulfur-loaded sorbent particulates from reactor receiver 26 and regenerator 14, and changes the pressure and composition of the environment surrounding the sulfur-loaded sorbent particulates from a high pressure hydrocarbon environment to a low pressure inert (e.g., nitrogen and/or argon) environment. After the environment of the sulfur-loaded sorbent particulates has been transitioned, as described above, the sulfur-loaded sorbent particulates are batch-wise transported from reactor lockhopper 28 to regenerator 14. Because the sulfur-loaded solid particulates are continuously withdrawn from reactor 12 but processed in a batch mode in reactor lockhopper 28, reactor receiver 26 functions as a surge vessel wherein the sulfur-loaded sorbent particulates continuously withdrawn from reactor 12 can be accumulated between transfers of the sulfur-loaded sorbent particulates from reactor receiver 26 to reactor lockhopper 28. Thus, reactor receiver 26 and reactor lockhopper 28 cooperate to transition the flow of the sulfur-loaded sorbent particulates between reactor 12 and regenerator 14 from a continuous mode to a batch mode.

Second transport assembly 20 generally comprises a regenerator lifting device, such as, for example, a pneumatic lift, 32, a regenerator receiver 34, and a regenerator lockhopper 36 fluidly disposed between regenerator 14 and reducer 16. During operation of desulfurization unit 10 the regenerated sorbent particulates are continuously withdrawn from regenerator 14 and lifted by regenerator pneumatic lift 32 from regenerator 14 to regenerator receiver 34. Regenerator receiver 34 is fluidly coupled to regenerator 14 via a regenerator return line 38. The lift agent, such as for example, a gas, used to transport the regenerated sorbent particulates from regenerator 14 to regenerator receiver 34 is separated from the regenerated sorbent particulates in regenerator receiver 34 and returned to regenerator 14 via regenerator return line 38. Regenerator lockhopper 36 is operable to transition the regenerated sorbent particulates from the low pressure oxygen environment of regenerator 14 and regenerator receiver 34 to the high pressure hydrogen environment of reducer 16. To accomplish this transition, regenerator lockhopper 36 periodically receives batches of the regenerated sorbent particulates from regenerator receiver 34, isolates the regenerated sorbent particulates from regenerator receiver 34 and reducer 16, and changes the pressure and composition of the environment surrounding the regenerated sorbent particulates from a low pressure oxygen environment to a high pressure hydrogen environment. After the environment of the regenerated sorbent particulates has been transitioned, as described above, the regenerated sorbent particulates are batch-wise transported from regenerator lockhopper 36 to reducer 16. Because the regenerated sorbent particulates are continuously withdrawn from regenerator 14 but processed in a batch mode in regenerator lockhopper 36, regenerator receiver 34 functions as a surge vessel wherein the sorbent particulates continuously withdrawn from regenerator 14 can be accumulated between transfers of the regenerated sorbent particulates from regenerator receiver 34 to regenerator lockhopper 36. Thus, regenerator receiver 34 and regenerator lockhopper 36 cooperate to transition the flow of the regenerated sorbent particulates between regenerator 14 and reducer 16 from a continuous mode to a batch mode.

Third transport assembly 22 includes a slide valve 40 and a pneumatic lift 42. When slide valve 40 is opened, reduced sorbent particulates are withdrawn from reducer 16 and transported to pneumatic lift 42. Lifting device, such as, for example, a pneumatic lift, 42 is operable to transport the reduced sorbent particulates back to reactor 12. No lockhopper is required in third transport assembly 22 because the conditions in reducer and reactor are similar, and there is no harm in allowing some of the hydrogen environment of reducer 16 to enter the hydrocarbon/hydrogen environment in reactor 12.

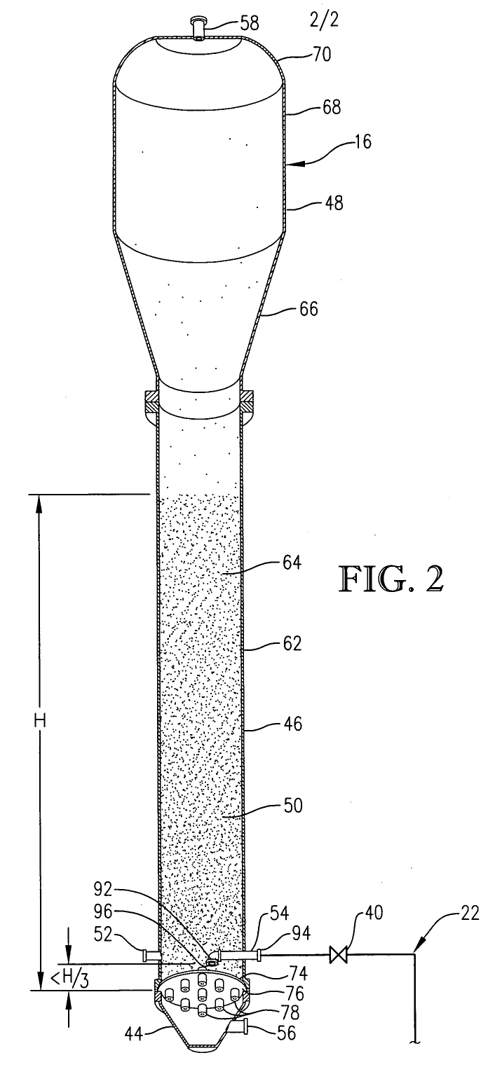

Referring now to FIG. 2, reducer 16 is illustrated as generally comprising a plenum 44, a reactor section 46, a disengagement section 48, and a fluidized bed 50 of regenerated sorbent particulates and reduced sorbent particulates. The regenerated solid sorbent particulates are provided to reducer 16 via a solids inlet 52 in reactor section 46. The reduced solid sorbent particulates are withdrawn from reducer 16 via a sorbent draw 54. The hydrogen-containing fluid stream is charged to reducer 16 via a fluid inlet 56 in plenum 44. Once in reducer 16, the hydrogen-containing fluid stream flows upwardly through reactor section 46 (where it contacts and fluidizes the sorbent particulates) and disengagement section 48 (where it is substantially separated from the sorbent particulates) and exits a fluid outlet 58 in the upper portion of disengagement section 48.

Reactor section 46 includes a substantially cylindrical reactor section wall 62 which defines an elongated, upright, substantially cylindrical reducing zone 64 within reactor section 46. Reducing zone 64 preferably has a height in the range of from about 5 to about 60 feet, more preferably in the range of from about 8 to about 30 feet, and most preferably in the range of from 10 to 20 feet, for best reducing operations. Reducing zone 64 preferably has a width (i.e., diameter) in the range of from about 1 to about 10 feet, more preferably in the range of from about 0.5 to about 6 feet, and most preferably in the range of from 1.0 to 2.5 feet, for best reducing operations. The ratio of the height of reducing zone 64 to the width (i.e., diameter) of reducing zone 64 is preferably in the range of from about 2:1 to about 20:1, and most preferably in the range of from about 5:1 to about 15:1, for best reducing operations. In reducing zone 64, the upwardly flowing hydrogen-containing fluid is passed through the solid sorbent particulates to thereby create fluidized bed 50 of solid particulates. It is preferred for fluidized bed 50 of solid particulates to be substantially contained within reducing zone 64. During normal operation of reducer 16, the height of fluidized bed 50 is preferably in the range of from about 5 to about 50 feet, more preferably in the range of from about 8 to about 20 feet, and most preferably in the range of from 10 to 16 feet. The fluidized density of fluidized bed 50 is preferably in the range of from about 20 to about 60 lb/ft³, more preferably in the range of from about 30 to about 50 lb/ft³, and most preferably in the range of from 35 to 45 lb/ft³. These parameters provide best reducing operations.

Disengagement section 48 generally includes a generally frustoconical lower wall 66, a generally cylindrical mid-wall 68, and an upper cap 70. Disengagement section 48 defines a disengagement zone within reducer 16. It is preferred for the cross-sectional area of disengagement section 48 to be substantially greater than the cross-sectional area of reactor section 46 so that the velocity of the fluid flowing upwardly through reducer 16 is substantially lower in disengagement section 48 than in reactor section 46, thereby allowing solid particulates entrained in the upwardly flowing fluid to “fall out” of the fluid in the disengagement zone due to gravitational force. It is preferred for the maximum cross-sectional area of the disengagement zone defined by disengagement section 48 to be in the range of from about two to about ten times greater than the maximum cross-sectional area of reducing zone 64, most preferably in the range of from 3.5 to 4.5 times greater than the maximum cross-sectional area in reaction zone 64.

Reducer 16 includes a distribution grid 74 located at the junction of plenum 44 and reactor section 46. Distribution grid 74 defines the bottom of reducing zone 64. Distribution grid 74 generally comprises a substantially disc-shaped distribution plate 76 and a plurality of bubble caps 78. Each bubble cap 78 defines a fluid opening therein, through which the fluid entering plenum 44 through fluid inlet 56 may pass upwardly into reaction zone 64. Distribution grid 74 preferably includes in the range of from about 2 to about 50 bubble caps 78, more preferably in the range of from about 3 to about 8 bubble caps 78. Bubble caps 78 are operable to prevent a substantial amount of solid particulates from passing downwardly through distribution grid 74 when the flow of fluid upwardly through distribution grid 74 is terminated.

Sorbent draw 54 is operable to withdraw sorbent particulates from reducing zone 64. Sorbent draw 54 is preferably a generally angled, or L-shaped, conduit extending through reactor section wall 62. Sorbent draw 54 includes a first end 92 disposed in reducing zone 64 and a second end 94 disposed outside of reducing zone 64. Second end 94 of sorbent draw is fluidly coupled to third transport assembly 22 upstream of slide valve 40. First end 92 presents a draw opening 96 that faces generally downward towards distribution grid 74. When slide valve 40 of third transport assembly 22 is opened, sorbent particulates from fluidized bed 50 enter sorbent draw 54 via draw opening 96 and are conducted by sorbent draw 54 to third transport assembly 22 for transport to reactor 12.

It has been discovered that the location at which sorbent particulates are withdrawn from fluidized bed 50 in reducer 16 has a significant impact on the ability of third transport assembly 22 to reliably transport the sorbent particulates from reducer 16 to reactor 12. FIG. 2 shows fluidized bed 50 having a vertical height “H” above distribution grid 74. The bottom of fluidized bed 50 is defined by distribution grid 74 while the top of fluidized bed 50 is defined at the elevation where the fluidized density of the sorbent particulates drops to less than 75 percent of the average fluidized density near the middle of fluidized bed 50. It is an important aspect of the present invention that the sorbent particulates withdrawn from reducer 16 via sorbent draw 54 are withdrawn from fluidized bed 50 at a draw location (i.e., the location of draw opening 96) that is spaced from distribution grid 74 a vertical distance less than one-third the total height “H” of fluidized bed 50. Thus, if fluidized bed 50 were divided into three equal vertical sections (i.e., a top one-third, a middle one-third, and a bottom one-third portion), the sorbent particulates would be withdrawn from the bottom one-third of fluidized bed 50. Most preferably, the sorbent particulates are withdrawn from a bottom one-fourth of fluidized bed 50.

Reasonable variations, modifications, and adaptations may be made within the scope of this disclosure and the appended claims without departing from the scope of this invention.

That which is claimed is:

1. A desulfurization unit comprising:
a reducer vessel defining a reducing zone, wherein said reducer vessel includes a distribution grid configured to allow a fluid to flow upwardly therethrough and into the reducing zone;
a fluidized bed of sorbent particulates disposed in the reducing zone and located generally above the distribution grid,
wherein said reducer vessel includes a sorbent draw for removing a portion of said sorbent particulates from said reducing zone,
wherein said sorbent draw includes a draw opening through which said sorbent particulates enters the sorbent draw from said reducing zone,
wherein said draw opening is vertically spaced from said distribution grid a draw height that is less than about one third the height of said fluidized bed.

2. The desulfurization unit according to claim 1, wherein said sorbent draw includes a generally L-shaped conduit having a first end positioned in said reducing zone and a second end positioned outside said reducing zone and wherein said first end presents said draw opening.

3. The desulfurization unit according to claim 2, wherein said draw opening faces generally towards said distribution grid.

4. The desulfurization unit according to claim 1, wherein said sorbent particulates comprise zinc oxide and a promoter metal component.

5. The desulfurization unit according to claim 4, wherein said promoter metal component comprises a promoter metal selected from the group consisting of nickel, cobalt, iron, manganese, tungsten, silver, gold, copper, platinum, zinc, ruthenium, molybdenum, antimony, vanadium, iridium, chromium, and palladium.

6. The desulfurization unit according to claim 5, wherein said promoter metal component comprises a substitutional solid solution of zinc and said promoter metal.

7. The desulfurization unit according to claim 6, wherein said promoter metal is nickel.

8. The desulfurization unit according to claim 1, wherein said sorbent particulates have a Group A Geldart characterization.

9. The desulfurization unit according to claim 1, wherein said sorbent particulates have a mean particle size in the range of from about 20 to about 300 microns and wherein said sorbent particulates have an average density in the range of from about 0.5 to about 1.5 grams per cubic centimeter.

10. The desulfurization unit according to claim 1, wherein said fluidized bed has a height in the range of from about 5 to about 50 feet.

11. The desulfurization unit according to claim 10, wherein said fluidized bed has a fluidized density in the range of from about 20 to about 60 pounds per cubic foot.

12. The desulfurization unit according to claim 11, wherein said draw height is less than one fourth the height of said fluidized bed.

13. The desulfurization unit according to claim 12, wherein said fluidized bed has a height in the range of from about 8 to about 20 feet.

14. A desulfurization unit employing fluidizable and circulatable sorbent particulates, said desulfurization unit comprising:
a reactor containing a first fluidized bed of said sorbent particulates;
a regenerator containing a second fluidized bed of said sorbent particulates;
a reducer containing a third fluidized bed of said sorbent particulates;
a first transport assembly for transporting said sorbent particulates from said reactor to said regenerator;
a second transport assembly for transporting said sorbent particulates from said regenerator to said reducer; and
a third transport assembly for transporting said sorbent particulates from said reducer to said reactor,
wherein said reducer includes a sorbent draw fluidly coupled to the third transport assembly and operable to withdraw said sorbent particulates from said third fluidized bed,
wherein said sorbent draw is configured to withdraw said sorbent particulates from a bottom one third of said third fluidized bed.

15. The desulfurization unit according to claim 14, wherein said third fluidized bed has a height in the range of from about 5 to about 50 feet.

16. The desulfurization unit according to claim 15, wherein said third fluidized bed has a fluidized density in the range of from about 20 to about 60 pounds per cubic foot.

17. The desulfurization unit according to claim 16, wherein said sorbent draw is configured to withdraw said sorbent particulates from a bottom one fourth of said third fluidized bed.

18. The desulfurization unit according to claim 14, wherein said sorbent particulates comprise zinc oxide and a promoter metal component.

19. The desulfurization unit according to claim 18, wherein said promoter metal component comprises a promoter metal selected from the group consisting of nickel, cobalt, iron, manganese, tungsten, silver, gold, copper, platinum, zinc, ruthenium, molybdenum, antimony, vanadium, iridium, chromium, and palladium.

20. The desulfurization unit according to claim 19, wherein said promoter metal is nickel.

21. The desulfurization unit according to claim 14, wherein said sorbent particulates have a mean particle size in the range of from about 20 to about 300 microns and wherein said sorbent particulates have an average density in the range of from about 0.5 to about 1.5 grams per cubic centimeter.

22. A method of desulfurizing a hydrocarbon-containing fluid stream, said method comprising the steps of:
(a) contacting sorbent particulates with said hydrocarbon-containing fluid stream in a reactor to thereby remove sulfur from said hydrocarbon-containing fluid stream and provide sulfur-loaded sorbent particulates;
(b) transporting at least a portion of said sulfur-loaded sorbent particulates from said reactor to a regenerator;
(c) contacting said sulfur-loaded sorbent particulates with an oxygen-containing stream in said regenerator to thereby provide regenerated sorbent particulates;
(d) transporting at least a portion of said regenerated sorbent particulates from said regenerator to a reducer;
(e) contacting said regenerated sorbent particulates with a hydrogen-containing stream in said reducer to thereby provide reduced sorbent particulates; and
(f) transporting at least a portion of said reduced sorbent particulates from said reducer to said reactor,
wherein step (e) includes fluidizing said regenerated and reduced sorbent particulates with said hydrogen-containing stream in said reducer to thereby form a fluidized bed of said regenerated sorbent particulates and said reduced sorbent particulates in said reducer,
wherein step (f) includes removing at least a portion of said reduced sorbent particulates from said reducer at a draw location positioned proximate a bottom one third of said fluidized bed.

23. The method according to claim 22, wherein step (e) includes producing water in said reducer via reaction of said regenerated sorbent particulates with said hydrogen-containing stream.

24. The method according to claim 23, wherein step (e) includes passing said hydrogen-containing stream through said reducer at a superficial velocity in the range of from about 0.2 to about 2.0 feet per second and wherein said hydrogen-containing stream comprises predominantly hydrogen.

25. The method according to claim 24, wherein step (e) is performed at a reducing temperature in the range of from about 600 to about 1,000° F. and a reducing pressure in the range of from about 100 to about 400 psig.

26. The method according to claim 22, wherein said regenerated sorbent particulates comprise an oxidized promoter metal component, wherein said reduced sorbent particulates comprise a reduced promoter metal component, and wherein step (e) includes reducing at least a portion of said oxidized promoter metal component to thereby form said reduced promoter metal component.

27. The method according to claim 26, wherein said oxidized promoter metal component comprises a substitutional solid metal oxide solution including zinc and a promoter metal and wherein said reduced promoter metal component comprises a substitutional solid metal solution including zinc and said promoter metal.

28. The method according to claim 27, wherein said promoter metal is selected from the group consisting of nickel, cobalt, iron, manganese, tungsten, silver, gold, copper, platinum, zinc, ruthenium, molybdenum, antimony, vanadium, iridium, chromium, and palladium.

29. The method according to claim 28, wherein said substitutional solid metal oxide solution is characterized by the formula M_{X}Zn_{Y}O and said substitutional solid metal solution is characterized by the formula M_{A}Zn_{B}, wherein M is said promoter metal and wherein X, Y, A, and B are each numerical values in the range of from 0.01 to 0.99.

30. The method according to claim 29, wherein said promoter metal is nickel.

31. The method according to claim 22, wherein said fluidized bed has a height in the range of from about 5 to about 50 feet.

32. The method according to claim 31, wherein said draw location is positioned proximate a bottom one fourth of said fluidized bed.

33. The method according to claim 32, wherein said fluidized bed has a height in the range of from about 8 to about 20 feet.
